(19) United States
(12) Patent Application Publication
(10) Pub. No.: US 2026/0232134 A1
(43) Pub. Date: Aug. 13, 2026

(54) CLAMSHELL GRILL FOR NON-FLAT FOOD PRODUCTS

(71) Applicant: STEARNS PRODUCT DEVELOPMENT CORPORATION, Perris, CA (US)

(72) Inventors: Steven Raio, Canyon Lake, CA (US); Juan Martinez, Perris, CA (US); Howard J. Frantz, Irvine, CA (US)

(21) Appl. No.: 19/532,261

(22) Filed: Feb. 6, 2026

Related U.S. Application Data
(60) Provisional application No. 63/755,964, filed on Feb. 7, 2025.

(51) Int. Cl. A47J 37/06

(52) U.S. Cl. CPC A47J 37/0611; A47J 2037/0617

(57) ABSTRACT

A clamshell heating apparatus for elongate food items includes a lower platen and an upper platen, at least one platen having a plurality of elongate concave channels defined by arcuate or cylindrical-segment profiles that increase conductive surface contact while limiting deformation of cylindrical products such as burritos, wraps, and sandwiches. A tapered lead-in surface at an operator-facing front edge of the lower platen facilitates safe manual access upon opening. An adjustable stop defines a closed position and maintains a repeatable minimum separation distance between the platens, providing consistent compression independent of the number, size, or placement of items.

### CROSS-REFERENCE TO RELATED APPLICATIONS

This application claims the benefit of U.S. Provisional Application Ser. No. 63/755,964, filed Feb. 7, 2025, the contents of which are expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to food preparation equipment, and more specifically to clamshell heating apparatuses for elongate, non-flat food items.

### 2. Description of the Related Art

Clamshell grills are widely used in commercial and residential kitchens to heat and finish food products by compressing them between two heated platens. Conventional units typically employ substantially planar cooking surfaces and, in some cases, shallow grooves intended to create grill marks or direct grease away from the product. These designs perform adequately for relatively flat items such as panini sandwiches, but they are less effective for cylindrical or non-flat products, including burritos, wraps, and submarine sandwiches. When a cylindrical item is pressed between planar platens to increase contact area, the product often deforms, the outer portion of the food product may crease or rupture, and heating may become uneven due to limited circumferential contact.

Operational variability further complicates consistent results. Many clamshell grills rely on the weight of the upper platen and floating hinges to establish closure, so the compression applied to any given item depends on the number of items under the lid, their diameters, and their placement. This leads to inconsistent heat transfer rates and textures from one cycle to the next. Additionally, the lack of a physical stop to limit closure can cause overcompression of delicate products, while narrow grooves or grease channels—optimized for marking or drainage—do not cradle cylindrical items and can create localized pinch points and non-uniform heating. Safe removal may also be a concern, as operators must reach near hot surfaces to grasp the product when the lid opens, increasing the risk of burns and slowing throughput.

Therefore, there is a need in the art for a heating apparatus specifically configured and adapted to more efficiently heat non-flat food items while preserving the intended form of the food item. Various aspects of the present disclosure address this particular need, as will be discussed in more detail below.

### BRIEF SUMMARY

In accordance with one embodiment of the present disclosure, a clamshell heating apparatus includes a lower platen and an upper platen, with at least one of the platens providing a plurality of elongate concave channels defined by arcuate or cylindrical-segment profiles that increase conductive contact with an elongate food item while limiting deformation. The lower platen may include a tapered lead-in surface adjacent an operator-facing front edge that facilitates manual access to the food item upon opening. An adjustable stop may define a closed position and maintains a repeatable minimum separation distance between the platens in the closed position to prevent overcompression.

In certain embodiments, the concave channels are provided in both platens in mutually registered opposition to enhance wrap-around contact, while other embodiments employ the channels in only one platen. The arcuate or cylindrical-segment profiles may have radii selected to correspond to nominal food diameters and can be arranged as parallel troughs separated by intervening ribs to add stiffness and reduce thermal bleed. Some channels may include non-uniform depth or compound curvature to accommodate a range of sizes. The tapered lead-in surface may define an angle within a selected range relative to the primary heating surface to improve access and safety. The adjustable stop may be realized as a calibrated threaded stop, an eccentric cam, or a shim stack providing discrete, repeatable gaps.

Further embodiments may include a locking closure that may hold the platens at the minimum separation distance independent of product count or placement, as implemented by magnetic coupling or an electromagnet that engages at closure and releases after a timed interval. The locking closure may also be mechanical, such as a detent pin, cam, or latch mechanism. A floating hinge may be used for self-leveling while the stop defines the terminal spacing. An adjustable balance spring may set downward force without defeating the stop's protective function. In some versions, the upper platen includes spring-biased pins moveable relative to a base body to absorb peak closure loads and conform to surface variations. Split-lid configurations can be provided with independently operable sub-platen assemblies, each having its own adjustable stop and closed position.

In another aspect, the apparatus includes electric heating elements coupled to the platens and a controller configured to regulate platen temperatures and coordinate timing with the adjustable stop and any locking closure to maintain the closed position for a selected heating interval.

In a further aspect, a method of heating an elongate food item includes adjusting an adjustable stop on a clamshell heating apparatus having opposed platens with elongate concave channels, and an optional, tapered lead-in surface, placing the food item on the lower platen aligned with at least one channel, lowering the upper platen until the adjustable stop defines the closed position at a repeatable minimum separation distance independent of load, maintaining the closed position for a selected heating interval to increase conductive contact while limiting deformation, raising the upper platen, and removing the food item adjacent the tapered lead-in surface. The method can further include engaging a locking closure to hold the platens at the minimum separation distance for the selected interval and releasing the closure upon completion.

The apparatus may include an operator interface with indexed gap indicators correlated to common product diameters. The apparatus may also include interchangeable platen inserts or liners that define alternative channel radii and pitches. The apparatus may further comprise non-stick, food-safe coatings applied to the channels and ribs. The apparatus may include multi-zone heating with independent temperature control for different platen regions. The apparatus may also include embedded temperature sensors within ribs or channel floors for closed-loop control. The apparatus may further comprise thermal isolation structures or skirts to limit heat loss at edges. The apparatus may include a cool-touch guard proximate the front edge adjoining the tapered lead-in surface. The apparatus may also include a removable drip tray and optional drainage passages positioned away from the channels. The apparatus may further comprise quick-release hinges or linkages for sanitation. The apparatus may include materials selections for the platens including bare aluminum, anodized aluminum, stainless steel, or ceramic-coated metals.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is an upper perspective view of a clamshell heating apparatus having upper and lower platens with elongate concave channels sized to receive elongate food items and a tapered lead-in surface at a front edge of the lower platen;

FIG. 2 is a front cross-sectional view of the apparatus in a partially open position showing opposing arcuate channels on the upper and lower platens and a tapered lead-in surface adjacent the operator-facing front edge;

FIG. 3 is a front cross-sectional view of the apparatus in a closed position with the adjustable stop defining a repeatable minimum separation distance between the platens and the arcuate channels providing distributed wrap-around contact;

FIG. 4 is a partial cutaway side view of the apparatus as the upper platen descends toward the lower platen, highlighting self-leveling approach and the tapered lead-in surface;

FIG. 5 is a partial cutaway side view of the apparatus in the closed condition over a burrito with the adjustable stop arresting travel to provide controlled compression and uniform heating;

FIG. 6 is a side schematic view of one embodiment in which the upper portion can pivot and translate relative to the lower portion in a partially open state via a linkage permitting compound motion;

FIG. 7 is a side schematic view of the embodiment of FIG. 6 in the closed position with the linkage settling the upper platen into parallelism and the adjustable stop defining the closed position;

FIG. 8 is a cross-sectional schematic illustrating the transition toward the closed position with the adjustable stop preset to establish a repeatable minimum separation distance and opposing arcuate channels progressively enveloping the food item;

FIG. 9 is a cross-sectional schematic of the apparatus in the closed position with a locking mechanism engaged to hold the platens at the minimum separation distance established by the adjustable stop, the locking mechanism comprising magnetic or electromagnetic elements;

FIG. 10 is a cross-sectional schematic of an embodiment in which the upper platen includes a plurality of spring-biased adjustable heating pins moveable relative to a base body to conform to different geometries of elongate food items and promote uniform heat transfer; and

FIG. 11 is a cross-sectional schematic of the embodiment of FIG. 10 in the closed position with the adjustable heating pins displaced to positions determined by local surface contour and the preset minimum separation distance, forming a quasi-conformal contact pattern to provide uniform heating.

Common reference numerals are used throughout the drawings and the detailed description to indicate the same elements.

### DETAILED DESCRIPTION

The detailed description set forth below in connection with the appended drawings is intended as a description of certain embodiments of a griddle and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

In various embodiments, the present disclosure provides a clamshell heating apparatus 10 configured to efficiently heat elongate, non-flat food items 12, such as burritos, while preserving shape and structural integrity of the food items Unlike conventional flat-plate grills that increase pressure to achieve contact and consequently deform cylindrical products, the apparatus 10 employs one or more platens formed with elongate concave channels 14 having arcuate profiles selected to increase conductive surface contact with the outer wrapper (e.g., tortilla or foil) of the product while limiting flattening and rupture. The concave profiles of the food-receiving channels cradle differing diameters of burritos, wraps, and submarine sandwiches to promote rapid and uniform heat transfer over a greater portion of the circumference than achievable with planar surfaces. An adjustable stop 16 may define a closed position and maintains a repeatable minimum separation distance between the platens, preventing overcompression and delivering reproducible thermal contact conditions whether a single item or multiple items are present. A tapered lead-in surface 18 adjacent an operator-facing front edge of the lower platen provides clearance to grasp the food item upon opening without contacting heated surfaces, enhancing safety and throughput.

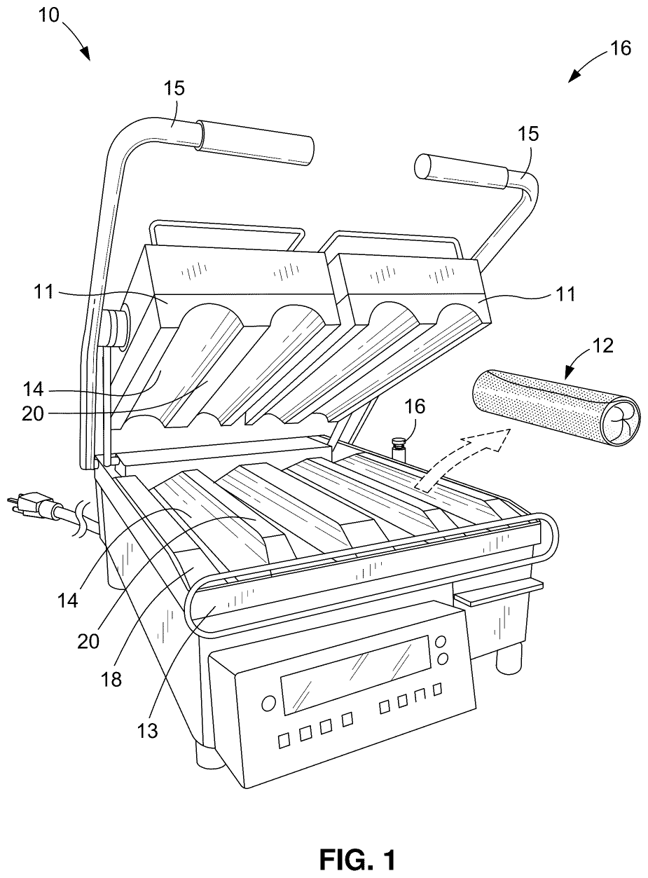

FIG. 1 illustrates an apparatus 10 having upper and lower platens 11, 13 whose primary heating surfaces are formed with elongate concave channels 14 sized to receive burritos, wraps, and other cylindrical food items 12 along their longitudinal axes. The apparatus 10 may include handles 15 attached to the upper platens 11 to facilitate raising and lowering the upper platens 11 relative to the lower platen 13. Each channel 14 presents an arcuate, cylindrical-segment profile that substantially conforms to the outer circumference of the food item 12, providing distributed, increased conductive contact over a large surface area without imposing creasing or localized pinch points. The channels 14 are dimensioned with radii and widths selected to cradle typical burrito diameters so that the food item 12 nests within the trough rather than bridging over adjacent peaks. The arcuate configuration of the channels 14 may have a uniform radius, or non-uniform radius, as may be desired to optimize conformance to the food item 12. In the case of a non-uniform radius, the channel 14 may have a cross sectional profile similar to that of a shallow-arc. Intervening ribs 20 between channels may help to maintain structural stiffness and thermal isolation, while smooth, filleted transitions at channel borders reduce the risk of tearing the outer portion of the food item 12 when the platens 11, 13 are closed. In use, the adjustable stop 16 defines the closed position so the contact pressure experienced by each burrito 12 is uniform regardless of the number of items placed on the griddle 10.

The disclosed channels 14 differ fundamentally from the narrow grooves found on panini griddles and grease-management channels of conventional clamshell grills, which are typically shallow, narrow, and optimized for visual marking or fluid drainage rather than as load-bearing cradles. By contrast, the channels 14 are broad concave troughs having curvature matched to product diameter and an aspect ratio that favors surface conformity and heat transfer over marking or drainage, producing greater conductive area, lower peak stresses, and more uniform heating. For instance, many burritos are made to define a diameter typically in the range of 2-4 inches, and thus, the channels 14 are designed to accommodate such sizes.

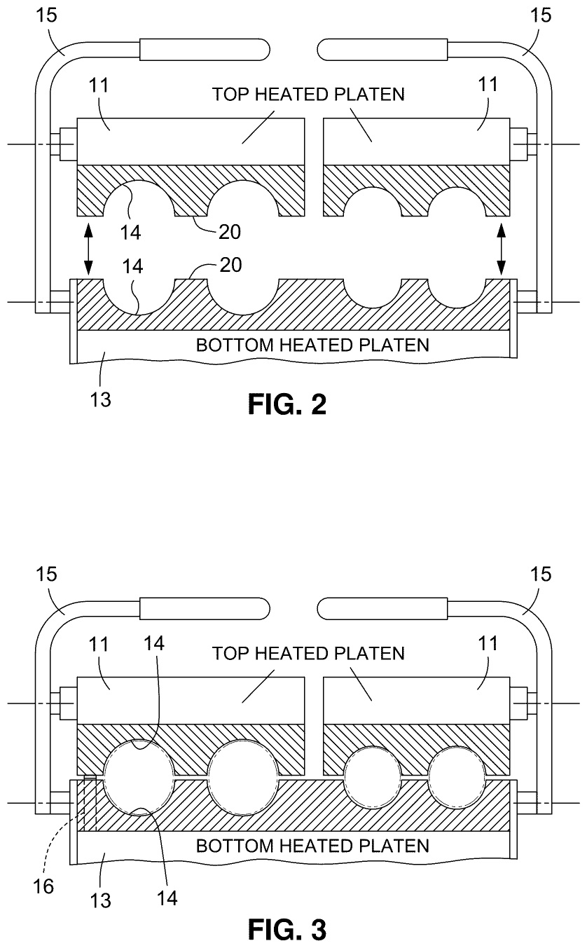

FIG. 2 depicts a cross-section of the apparatus 10 in a partially open position, showing the upper platens 11 vertically separated from the lower platen 13. Along these lines, the apparatus 10 may include multiple upper platens 11 that are independently moveable relative to each other, and cooperate with a single lower platen 13. The elongate concave channel 14 in the platens 11, 13 are arranged in opposed relation relative to the corresponding channels 14 in the lower platen 13 so that, as the platens 11, 13 approach one another, the food item 12 is progressively enveloped by matched curvature rather than pinched between planar faces. Ribs 20 provide stiffness and act as thermal barriers that moderate heat bleed from one channel to the next, contributing to uniform heating. In the partially open position, the tapered lead-in surface 18 adjacent the operator-facing front edge of the lower platen 13 provides clearance to reach the end of the food item 12 without contacting a hot edge when transitioning between loading and unloading. This separation permits alignment of the food item 12 with the channels 14 prior to closure, promoting consistent engagement along the item's longitudinal axis.

FIG. 3 shows the corresponding cross-section in the closed position, with the upper platen 11 lowered until the adjustable stop 16 establishes a repeatable minimum separation distance between the platens 11, 13. In this position, the arcuate channels 14 of the upper and lower platens 11, 13 cooperate to apply distributed, wrap-around contact to the outer surface of the food item 12, increasing contact area with the food item 12 while limiting deformation and preventing rupture. Because the closed position may be set by the adjustable stop 16 rather than by the weight of the upper platen 11, the contact pressure remains consistent regardless of whether one or multiple items are present beneath the lid. Ribs 20 maintain spacing, while transitions at channel boundaries avoid sharp pinch points that could crease or tear the wrapper. After the heating interval, raising the upper platen 11 allows safe grasping and removal aided by the tapered lead-in 18.

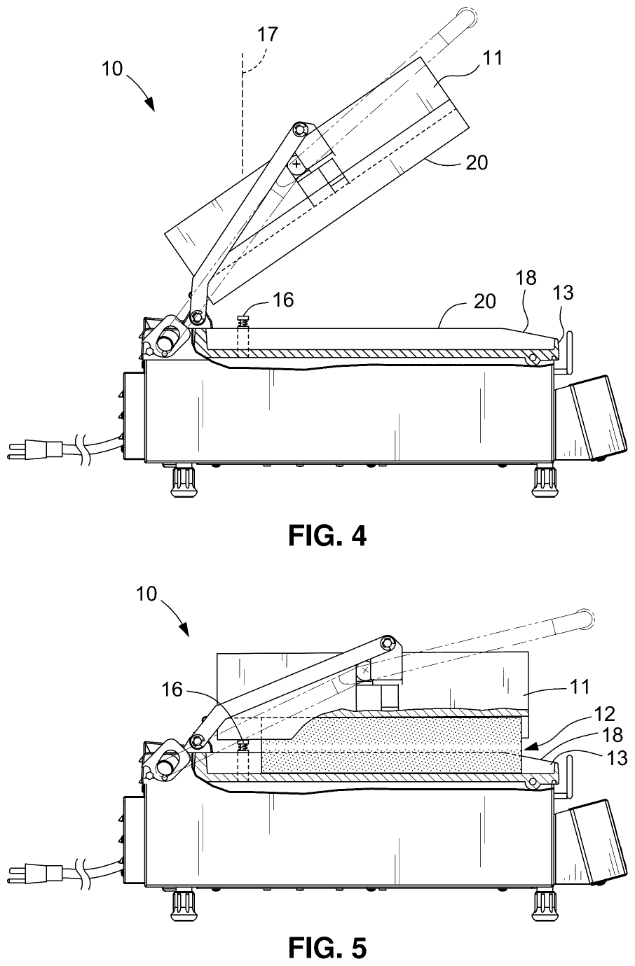

FIG. 4 presents a partial cutaway side view of the apparatus 10 as the upper platen 11 descends toward a burrito 12 (see FIG. 5) positioned on the lower platen 13. The upper platen 11 approaches with a self-leveling motion, which may be facilitated by a hinge connecting the upper platen 11 to the handle 15 that maintains parallelism relative to the lower platen 13 and encourages uniform engagement along the burrito's length. As the burrito 12 aligns within a concave channels 14 on the lower platen 13, the arcuate geometry cradles the cylindrical wrapper, distributing initial contact over a broad arc rather than at isolated points. During descent, the adjustable stop 16 limits terminal travel of the upper platen 11, ensuring that contact force is governed by the preset minimum separation distance rather than by instantaneous load or hinge dynamics. The length of the adjustable stop 16 may be adjusted along an axis 17 based on the desired stopping point. The axis 17 may be generally perpendicular to the longitudinal axis of the channels 14.

FIG. 5 shows a corresponding partial cutaway side view with the apparatus 10 in the closed condition over the burrito 12. The adjustable stop 16 defines the closed position at a repeatable minimum separation distance, and the upper and lower arcuate channels 14 cooperate to wrap the burrito 12 with distributed compressive contact. Because closure is arrested by the stop 16, the resulting contact pressure is consistent from cycle to cycle and independent of whether one or multiple food items are present. The concave profiles apply a gentle, circumferential force that increases conductive area while limiting flattening and preventing rupture of the tortilla or wrapper. Upon completion of the heating interval, releasing the closed condition allows the upper platen 11 to rise, with the tapered lead-in 18 facilitating safe grasping and removal. These views emphasize controlled, repeatable application of force and heat enabled by the channel geometry and stop-defined closure, distinguishing the apparatus 10 from conventional grills that rely on narrow grooves or weight-based closure and consequently produce uneven contact, inconsistent pressure, and greater product deformation.

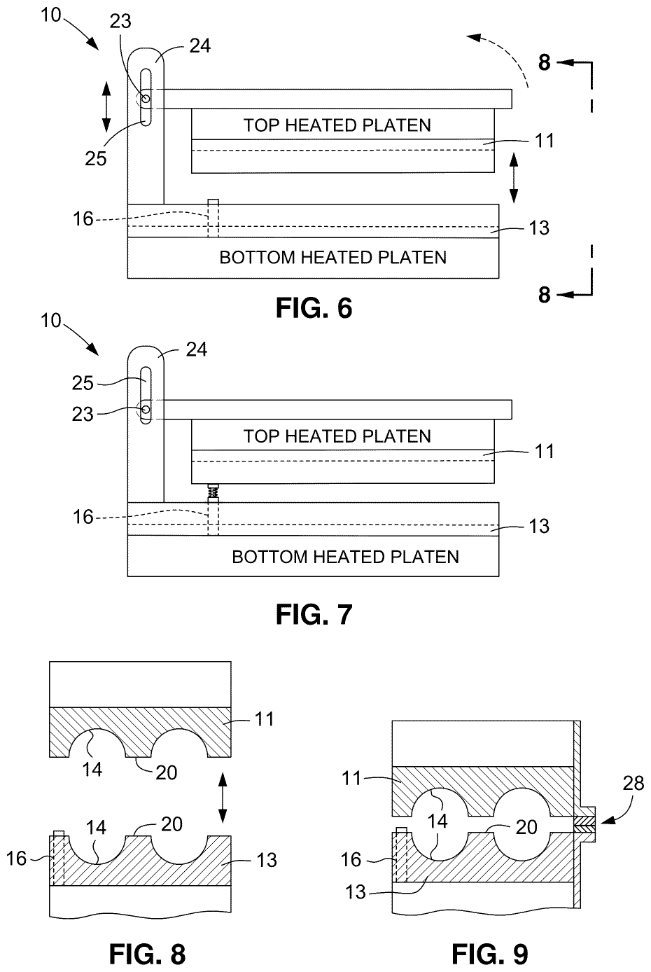

FIG. 6 illustrates an embodiment of apparatus 10 in which the upper portion is configured to pivot and translate relative to the lower portion as the apparatus transitions toward closure. In this partially open state, the upper platen 11 is coupled to a pin 23 that slides within a slot 25 formed in a linkage 24 that permits compound motion: a rotational degree of freedom about a pivot axis (defined by pin 23) to accommodate angular alignment, and a guided translational degree of freedom to adjust vertical and, in some embodiments, slight fore-aft positioning. This motion allows the upper platen 11 to self-level and to track the contour of the elongate food item 12 aligned within the concave channels 14 of the lower platen, reducing skew and mitigating localized high-pressure pinch points. The guided translation ensures that, even if burrito diameter varies or multiple items are present, the upper platen 11 approaches in a controlled path that promotes uniform wrap-around contact. The adjustable stop 16 arrests travel and defines a closed position at a repeatable minimum separation distance, so compound motion does not result in uncontrolled compression.

FIG. 7 shows the apparatus 10 in the closed position with the upper portion having pivoted and translated to a final, aligned orientation over the lower portion. The linkage 24 accommodates any angular misalignment and settles the upper platen 11 into parallelism with the lower platen, while the translational component sets vertical spacing at the distance governed by the adjustable stop 16. The result is consistent, circumferential contact over the burrito 12 by cooperating arcuate channels 14, yielding increased conductive area and controlled compression. Because the closed position is defined by the stop 16 rather than by hinge float or platen weight, the applied force is repeatable and independent of product count or placement. This pivot-and-translate upper portion distinguishes the apparatus 10 from conventional single-pivot clamshell grills, which can introduce edge loading or uneven contact when confronted with varying product thicknesses. By permitting compound motion constrained by a positive stop 16, the apparatus achieves self-leveling engagement, uniform pressure distribution, and reliable thermal performance across a range of elongate food item sizes. Although FIGS. 6 and 7 show one particular implementation of a pivot-and-translate hinge, other types of hinges may be incorporated into the apparatus 10 without departing from the spirit and scope of the present disclosure.

FIG. 8 illustrates the transition of the apparatus 10 toward the closed position, with the upper platen 11 descending relative to the lower platen 13 and the adjustable stop 16 determining the terminal approach. As the upper platen 11 nears the lower platen 13, opposing arcuate channels 14 progressively envelop the elongate food item 12, distributing contact over a broad circumferential area. The adjustable stop 16 is preset to establish a repeatable minimum separation distance between the platens 11, 13, so closure results in compression governed by geometry rather than lid weight or product count. In certain embodiments, the stop 16 includes a calibrated screw, cam, or shim arrangement that arrests travel at a defined spacing and carries compressive load during heating, maintaining consistent pressure even as the platens thermally expand. A balance spring can be tuned such that, while the stop 16 sets final spacing, closing force remains manageable for the operator and the upper platen returns upward at a controlled rate when the apparatus is released.

FIG. 9 depicts the apparatus 10 in the closed position with a locking mechanism 28 engaged to hold the platens 11, 13 at the minimum separation distance established by the adjustable stop 16. In one embodiment, magnetic elements on the upper and lower structures are positioned to come into registry as the stop 16 defines the closed position, magnetic attraction holding the platens together without relying on hinge torque. In another embodiment, an electromagnet energizes automatically upon detection that the closed position has been reached and releases upon completion of a timed heating interval, with a manual override provided for safety. Mechanical alternatives such as a latch, detent pin, or over-center cam may be used to achieve the same locked condition. In all cases, the locking mechanism 28 maintains the closed position independent of the number, size, or placement of food items and resists upward forces generated by elastic rebound of the product, while the adjustable stop 16 continues to bear against travel-limiting surfaces to preserve the preset separation. Upon expiration of the heating interval or actuation of a release control, the lock disengages and the upper platen lifts away under assistance from the balance spring, allowing the operator to remove the heated item via the tapered lead-in 18.

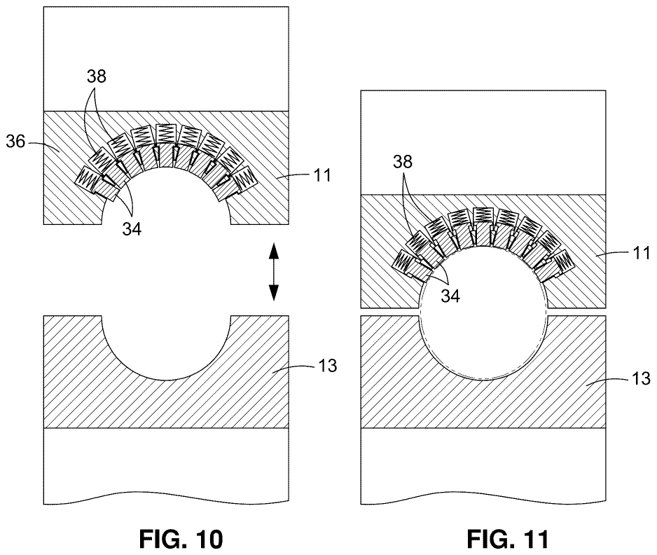

FIG. 10 illustrates an embodiment in which the upper platen includes a plurality of adjustable heating pins 34 arranged to conform to differing geometries of elongate food items 12 and to promote uniform heat transfer under controlled compression. Each pin 34 is received within a bore of a base body 36 of the upper platen and is moveable relative to the base 36 along a direction generally normal to the lower platen 13. Distal ends of the pins 34 define a contoured array that, in aggregate, approximates an arcuate or cylindrical-segment profile complementary to the outer surface of a burrito, wrap, or similar item. In this partially open state, the pins 34 protrude to a nominal position such that, upon closure, initial contact occurs across multiple pin tips distributed over a broad arc rather than at a single ridge. Each pin 34 is spring biased toward its extended position by a compliant element 38, such as a coil spring or elastomeric member seated between a shoulder of the pin 34 and a counterbore in the base 36. The spring bias allows the pins 34 to deflect individually as the outer surface of the food item 12 presents local variations in diameter, seam thickness, or ingredient distribution, thereby equalizing contact pressure and mitigating peak loads that could rupture the wrapper. Thermal coupling is provided through the base body 36, which is heated by internal elements, and through direct conduction from heated pin bodies 34, so the array establishes dense thermal contact while accommodating geometrical variability.

FIG. 11 shows the same embodiment in the closed position with the adjustable heating pins 34 engaged against the food item 12 and displaced to positions determined by the preset minimum separation distance and local surface contour. The adjustable stop 16 defines the closed position and limits the approach of the upper platen, while individual pins 34 compress their compliant elements 38 to different extents so that the net force applied to the food item 12 is distributed and controlled. In the closed state, pin tips collectively form a quasi-conformal contact pattern around the outer circumference of the burrito, increasing conductive area and promoting uniform heat flux without requiring the product to be flattened into a planar surface. Because each pin 34 can move relative to the base 36, the array adapts to different diameters and to mixed loads—e.g., a large burrito adjacent a smaller wrap—while maintaining consistent pressure across each item. Optional features include adjustable preload or spring-rate selection for the pins 34, interchangeable tip geometries (e.g., low-radius domed tips or shallow pads) to tune contact area, and thermal isolation bushings that manage heat flow into the compliant elements 38 to preserve compliance over repeated cycles. In combination with the stop-defined closure provided by the adjustable stop 16, the spring-biased pin architecture provides repeatable, uniform heating and controlled compression that distinguishes the apparatus 10 from conventional grills employing narrow grooves or static ridges, which concentrate force and produce uneven thermal contact on cylindrical food items 12.

As noted above, various aspects of the apparatus 10 are directed toward uniform application of pressure against the food item. Given that the food items may have minor variations, when one food item is compared to another, various modalities of achieving uniform pressure may be implemented into the apparatus 10. For instance, the apparatus 10 may include a torque sensor that measures torque in the hinge connecting the upper platen 11 and the lower platen 13, and displays the measured reading to the user on a user interface. When the torque reading correlates to a desired pressure, the user may maintain that pressure for a prescribed period of time before releasing the pressure and lifting the upper plate 11.

In certain embodiments, the upper platen 11 is coupled to the handle 15 by a ratchet-type pivot assembly configured to limit peak force transmitted to the food item while enabling the operator to achieve a prescribed compression. The assembly includes a handle 15 linked to the upper platen 11 through a ratcheting pivot and an overload decoupling interface calibrated to a target pressure. As the operator presses the handle 15 downward, the ratchet advances the upper platen 11 toward the lower platen 13 to increase contact until the prescribed pressure is reached. When additional force is applied beyond this threshold, the ratchet-type pivot permits relative downward movement of the handle 15 with respect to the upper platen 11, effectively acting as a shock absorber that dissipates excess input without further increasing the compressive load on the upper platen. This arrangement provides tactile feedback to the operator, maintains consistent compression independent of operator strength or momentary impulses, and reduces the likelihood of rupturing delicate wrappers while preserving uniform conductive contact.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A clamshell heating apparatus for heating an elongate food item, the apparatus comprising:
a lower platen and an upper platen, at least one of the platens including a plurality of elongate concave channels defined by arcuate profiles configured to increase conductive contact with the elongate food item while limiting deformation thereof, the lower platen having a tapered lead-in surface adjacent an operator-facing front edge to facilitate manual access to the elongate food item upon opening; and
an adjustable stop that defines a closed position and is configured to maintain a repeatable minimum separation distance between the upper platen and the lower platen in the closed position to prevent overcompression.

2. The clamshell heating apparatus of claim 1, wherein the plurality of elongate concave channels are provided in both the upper platen and the lower platen and are arranged in opposed alignment such that corresponding channels on the upper platen and the lower platen are mutually registered.

3. The clamshell heating apparatus of claim 1, wherein the plurality of elongate concave channels are provided only in the lower platen.

4. The clamshell heating apparatus of claim 1, wherein the plurality of elongate concave channels are provided only in the upper platen.

5. The clamshell heating apparatus of claim 1, wherein the arcuate profiles have radii selected to correspond to nominal outer diameters of burritos, wraps, or sandwiches to increase wrap-around contact while limiting flattening.

6. The clamshell heating apparatus of claim 1, wherein the plurality of elongate concave channels are arranged as parallel troughs separated by intervening ribs that provide structural support between adjacent troughs.

7. The clamshell heating apparatus of claim 1, wherein at least some of the elongate concave channels have non-uniform depth or compound curvature along their width to cradle elongate food items of different diameters.

8. The clamshell heating apparatus of claim 1, wherein the tapered lead-in surface defines an angle between about 20 degrees and about 45 degrees relative to a primary heating surface of the lower platen.

9. The clamshell heating apparatus of claim 1, wherein the adjustable stop comprises a threaded stop screw having indexed markings to set the repeatable minimum separation distance.

10. The clamshell heating apparatus of claim 1, wherein the adjustable stop comprises an eccentric cam configured to vary the repeatable minimum separation distance upon rotation.

11. The clamshell heating apparatus of claim 1, wherein the adjustable stop comprises a removable shim stack configured to set discrete values of the repeatable minimum separation distance.

12. The clamshell heating apparatus of claim 1, further comprising a locking closure configured to hold the upper platen and the lower platen at the repeatable minimum separation distance in the closed position independent of a number, size, or placement of elongate food items.

13. The clamshell heating apparatus of claim 12, wherein the locking closure comprises magnetic elements on the upper platen and the lower platen arranged to magnetically couple when the platens reach the closed position defined by the adjustable stop.

14. The clamshell heating apparatus of claim 12, wherein the locking closure comprises an electromagnet configured to energize upon detection that the platens have reached the closed position and to de-energize upon completion of a timed heating interval.

15. The clamshell heating apparatus of claim 1, further comprising a floating hinge coupling the upper platen to a frame such that the upper platen self-levels relative to the lower platen, wherein the adjustable stop defines the closed position irrespective of hinge float.

16. The clamshell heating apparatus of claim 1, further comprising an adjustable balance spring coupled to the upper platen and configured to set a downward force applied by the upper platen, the adjustable stop limiting compression at the closed position.

17. The clamshell heating apparatus of claim 1, wherein the upper platen includes a plurality of spring-biased pins moveable relative to a base body of the upper platen and arranged to bear against an elongate food item to absorb peak closure loads and reduce rupture.

18. The clamshell heating apparatus of claim 1, wherein at least one of the platens includes a removable, replaceable contact surface having a non-stick food-safe coating to facilitate cleaning while preserving the elongate concave channel geometry.

19. A method of heating an elongate food item, the method comprising:
adjusting an adjustable stop on a clamshell heating apparatus including a lower platen and an upper platen, at least one of the platens having a plurality of elongate concave channels defined by arcuate or cylindrical-segment profiles configured to increase conductive contact with the elongate food item while limiting deformation thereof, the lower platen having a tapered lead-in surface adjacent an operator-facing front edge, the adjustable stop being configured to define a closed position and to maintain a repeatable minimum separation distance between the platens;
placing the elongate food item on the lower platen with the elongate food item aligned with at least one of the elongate concave channels;
lowering the upper platen until the adjustable stop defines the closed position at the repeatable minimum separation distance independent of a number, size, or placement of elongate food items;
maintaining the platens at the closed position for a selected heating interval to increase conductive contact with the elongate food item while limiting deformation thereof;
raising the upper platen; and
removing the elongate food item by grasping an end thereof adjacent the tapered lead-in surface.

20. The method of claim 19, further comprising engaging a locking closure to hold the platens at the repeatable minimum separation distance for the selected heating interval and disengaging the locking closure upon expiration of the selected heating interval.
